(19) United States
(12) Patent Application Publication
(10) Pub. No.: US 2005/0192863 A1
(43) Pub. Date: Sep. 1, 2005

(54) Web site vistor incentive program in conjunction with promotion of anonymously identifying a user and/or a group

(76) Inventor: Krishna Mohan, Naperville, IL (US)

Correspondence Address: Mr. Krishna Mohan, 3528 Breitwieser lane, Naperville, IL, 60564, US

(21) Appl. No.: 10/787,990

(22) Filed: Feb. 26, 2004

(51) Int. Cl. G06F 17/60

(52) U.S. Cl. 705/14

(57) ABSTRACT

Methods to promote usage of anonymously identifying a user to a web site over a computer network by providing an incentive program tied to a client identifier placed by the web site on a computer of the user. The incentive program account is created without requesting any user specific information and account is credited with bonus points based on user's browsing behavior with the web site and subsequent access to the account is possible only if the web site receives original client identifier. In case of loss of original client identifier, various means to recover the identifier is provided to the user. In another aspect, the program provides means to transfer bonus points between accounts and leverages this association of anonymous client identifiers to form an anonymous group profile. In preferred embodiment, the computer network is the Internet and the client identifier is located within a cookie file.

### CROSS-REFERENCE TO RELATED APPLICATIONS

Not Applicable.

### STATEMENT REGARDING FEDERALLY SPONSORED RESEARCH OR DEVELOPMENT

Not Applicable.

### SEQUENCE LISTING OR PROGRAM

Not Applicable.

### BACKGROUND OF THE INVENTION

1. Field of the Invention

The present invention, in its broader aspect, relates to an incentive award program for users of a computer network, for example, the Internet, and, more particularly, to an award program method for rewarding users of a web site on the computer network, wherein the incentive program account is linked to a anonymous user identifier placed by the web site on users' computer, thus, promoting the process of anonymously identifying users in conjunction with the award program and with mutual participation of the web site and users.

2. Background of the Invention

One of the most widely accepted and heavily used computer networks is the Internet. The Internet is a global system of interconnected computer networks formed into a single worldwide, wide area computer network. Various entities provide web sites on the Internet to promote products and services offered by them. Generally, these web sites are hosted on server computers and user browses (visits) these sites by using a web browser on a client computer (user computer) by connecting to the web site and downloading a web page from a web site.

Attracting users to a web site is very important for success of any e-commerce based business model. Attracting, keeping and making users to come back to visit a web site can have many direct and indirect benefits to the web site hosting business entity. Some businesses like Internet search engines, Internet based news providers, and the like, generate substantial income from advertising on the web site, for example, by placing “banner” advertisements. On the other hand, other business may use the Internet based web site to increase the awareness of product offerings, to launch new products and the like. By attracting users to such web sites, the business entity may realize the benefits in many forms, for example, increased sales of those products in super markets and departmental stores.

Some web sites, for example, iwon.com provides lottery style awards on daily basis for attracting visitors to their web site. This is one illustration of web sites placing importance to drawing visitors and their attention.

Many business entities use frequent customer programs for making users (customers) to keep coming back and to build a mutually profitable relationship. For a web site, making a user (visitor) to keep coming back and to promote loyalty may result in increased advertising revenue, increased attention of the user towards a positively priced information for the web site, for example, the web site publishing the launch of a new product and the like. Moreover, the web site can collect rich information about the user by placing a small text file on the user's computer, commonly known as “cookies” (hereinafter also referred as cookies or cookie, without double quotes). The cookie file creation process typically happens with little or no knowledge to an average computer user. Normally this process is considered more useful to the web site than the user, since, the web site can track and store user's activity patterns in the web site without even requesting the user to register or to establish an account with the site and can create a very rich information profile about the user. The user is anonymous to the web site, since a unique user identifier placed by the web site in the “cookie” file represents the user. Even though the user remains substantially anonymous to the web site and the user identifier is not directly usable by third party for contacting the user or for gaining monetarily from the user, the web site can use the rich profile generated to target the user with custom tailored advertisements and programs during subsequent browsing with the website by the user. Even though user may have limited benefit by such process, for example, access to a customized web page, many users envision the cookie approach as invasion of privacy.

Recently, computer users have been concerned that profile information gathered by such firms, as DoubleClick would be linked to name and address information. This has perceived by many people as spying and resulted in implementation of many cookie-blocking techniques. This defeats the very purpose of cookies. Further, the Internet user may be using more than one computer, for example, a computer at home, another computer for office use and yet another for travel use. A web site using cookie approach to anonymously identify user will perceive this as three different users instead of one. The user may not be interested in disclosing one anonymous identity to the user, since the user didn't benefit much from doing so. This decreases the quality of data collected by the web site.

Many web site store cookie related information in a cookie database and this may comprise various information regarding the user, for example, personal preferences, browsing patterns, buying patterns, etc. For example, an online news provider may collect users browsing behavior by collecting types of news information read by the user. If the user reads sports section frequently, browsing patterns stored in the cookie database against the anonymous user identifier can easily reveal very rich information about the user. The web site now can use such information in the cookie database for their benefit, for example, by providing tailored “banner” advertisements related to sports. Hence, the quality of data collected in the cookie database is very important factor to many web sites.

Quality of data in a cookie database of a web site can decrease due to various factors as described herein. One factor, which is already described earlier is, several anonymous “manifestation” of same user, to the web site due to the user accessing the web site from multiple computers. This is mainly because there is no incentive to the user for consistently providing one such anonymous identifier to the web site. Alternatively, the web site can recognize same user by commonly used account setup with personal information and by setting an account with login identifier and password. However, many users hesitate to provide personal information and back away from such methods. Further, users need to remember login id and password with each web site. Furthermore, with many public web sites, like, search engines and online news providers, user may not like the idea of logging-in each time to access the site in order to participate in an incentive program. So a method with balanced approach is required in the art to register users into an incentive program without requesting any information, by linking the account with the client identifier such that users can receive incentive from the web site for their browsing behavior, whereas the web site benefit from improved quality of anonymous user profile data. Furthermore, the user of the web site should be able to participate in such incentive programs transparently, without directly logging into the account.

Another factor that can reduce the quality of data in a cookie or similar database is due to users deleting “cookie” or similar files from their computer. A user can delete a cookie file from his or her computer, instantly rendering all of the information stored in a cookie database of a web site, useless. For example, a search engine may have formed very rich profile based on an anonymous identifier for almost a year and uses this data to provide tailored advertisements to the user. If the user deletes the cookie file placed by the search engine, the search engine web site can no longer identify the same user with original cookie client identifier. Such deletion of cookie files may be intentional, accidental or due to lack of awareness of cookie file process on the part of the user. For example, a hard disk of user's computer may crash, causing loss of cookie files or user may buy a new computer. So there is a need in the art to induce interest in the Internet user community to promote recovery of such cookie files by the user. By linking an incentive program with a user identifier in the cookie file, the user have more reason to do such recovery in order to keep points gained in the incentive program. Accordingly, the web site need to provide such recovery mechanisms tied to the incentive program.

Furthermore, using current cookie approach, web sites cannot anonymously identify a group of users, for example, a family, a business and the like. This is because, the user identifier placed by the web site in a cookie file is tied to a single user and unless the user discloses his or her association with other user identifier, formation of such association is not easily possible by the web site. Again, unless having some incentives, the user may not disclose such information, even though such information identifies the group anonymously. For example, a family or small business may have several computers used by different individuals representing the family or the small business. A web site may have placed a “cookie” file with a unique user ID on each of those computers. Even though, the Web site can anonymously identify these individuals by these user Ids, it can't figure out that these individuals belong to a common group. The Web site or its partners, if it had known about this added information, would have benefited from such information. For example, a restaurant chain can use such information to attract family dining or business parties by providing coupons and custom tailored advertisements.

Accordingly, there is need in the art to identify a common group of Internet users and to leverage the cookie or similar database to this newly identified association to form profitable group profiles; in conjunction with an incentive award program, wherein the mechanism for this association will be established with mutual benefit, wherein the group benefit from quick earning of an award.

Overall, there is a need in the art to provide an incentive program for users of the Internet for frequently visiting and performing certain activities with a web site; in conjunction with a method to promote the usage of a user identifier in a cookie or similar file placed by the web site, to solve or reduce aforementioned limitations. On another note, there is a requirement in the art for a method to share the benefits realized by a web site from placing a cookie or similar file on user's computer, with the user itself, who is the very reason for realization of the benefits by the web site. Such a method will induce an interest in the Internet user community to promote the method of anonymously identifying with a web site. Since the present invention method is based on mutual participation and such program is based on user consent, such a method would eliminate or reduce privacy concerns associated with existing cookie process, since the user is willing to enter into the process by understanding the mutual benefit. Further, such a method would create an environment, in which, users are more willing to disclose an association with other anonymous users, thereby enabling web sites to collect rich, yet anonymous, profiles of groups like families, businesses and the like.

There are many incentive programs exists in the art. However, they need user to provide some or other type of personal information, at least an email address of the user. Many times users gets attracted to an offer or an advertisement in a web site and withdraws quickly after the offer or the advertisement requesting personal information from the user. Many incentive programs require one or other form of personal information from the user.

What is needed is an incentive program for a user of a web site, wherein the incentive program account is setup automatically, without requesting any information from the user, not even an email address, besides the user approving the creation of the account and frequently accessed web sites can establish such accounts transparently with the user. For example, web sites like, a search engine or an online news provider and the like, should be able to establish an incentive program automatically and transparently with the user.

What is needed is an incentive program that is linked to a client identifier placed by the web site on a computer of the user wherein the incentive program account is accessible only if the web site receives the client identifier, thus, promoting the process of anonymously identifying the user, in conjunction with the incentive program and user participation.

What is needed is an incentive program that facilitates anonymous identification of groups like families, businesses and the like, by the web site, with mutual benefit to the users of the group and the web site.

What is needed is an incentive program in conjunction with the process of anonymously identifying users to reduce the privacy concerns associated with such process by making the user to actively involve in such process.

### BACKGROUND OF THE INVENTION-PRIOR ART

Many prior art techniques for rewarding a user of the Internet for some type of interaction behavior and the like exists and are discussed in following sections. Then the novel features and advantages of present invention, which was not possible with prior art is also described. Further, other novel features and advantages of the present invention may be realized by studying the following detailed description in conjunction with attached drawings.

Some web sites, for example, mypoints.com rewards consumers for reading and responding to targeted offers and surveys at the mypoints.com web site and through email advertising: consumers may collect points which can be redeemed for a wide variety if products and services. However, this approach needs users to register with the web site and disclose personal information like—name, email address, postal code, birth date, gender, etc. Users of the Internet have increasingly valued privacy and may not be willing to provide such information. Another drawback of these types of websites is that user needs to be aware of such websites. Typically, users, unlike a search engine, online news, etc, do not frequently visit these websites. Rather, users need to proactively visit these sites, register and participate in awardable activities, taking time out of frequently visited web sites.

Many other sites can award frequent visitors by requesting them to explicitly register with personal information or at least—an email address. In common, all of these incentive programs require a user to sign up with a program administrator or the like to earn benefits and usually requires the user to divulge private information that may be used for targeted advertising and product offers. Moreover the user needs to memorize login name and password. Sometimes, disclosing even an email address can cause the user to receive many targeted advertising emails in the mailbox, which can easily fill up and cause inconvenience to the user. Moreover, these approaches do not promote processes like “cookie” approach used by web sites, since the user can access the incentive program by using login id and password, even if the user loses the cookie file. The user may easily block or delete cookies from their computer and it should be noted that disadvantages mentioned earlier, couldn't be remedied with this approach.

Furthermore, many web sites like, online news and search engines are for public access and a user may not like the idea of logging into such web sites every time they visit. The prior art lacks the capability to reward a user transparently, while promoting consistent anonymous identification from the user.

U.S. Pat. No. 5,794,210 describe an attention brokerage system. Attention brokerage is the business of buying and selling the attention of consumers and the system provides compensation to the users for paying attention to an advertisement or the like information distributed over the Internet. This prior-art requires registration of both users and advertisers with the attention broker computer and requires an intermediate agent, which is the attention broker computer.

U.S. patent application 20030120542, titled “System and method for rewarding a user's interaction behavior with a computer system” discloses a technique for rewarding a web site visitor for following a hyperlink in a first document to a second document and then returning to the original document again. Intention of this invention is to avoid the user “getting lost” from the original web site by following subsequent other hyperlinks.

It should be noted that the present invention differs with respect to prior art, not because it provides an incentive program to a user of the Internet based on activities performed with a web site; but, because, it provides an incentive program in conjunction with user identifier placed by the web site on a computer of the user, in a such a way as to promote the process of anonymously identifying with the web site, while creating several mutually profitable opportunities to both of the user and the web site, as disclosed in the detailed description, figures and attached claims.

Other advantages of the present invention are readily apparent to one of skill in the art from the attached figures, detailed description and claims.

### BRIEF SUMMARY AND OBJECTS OF THE INVENTION

In one aspect of the present invention, a persistent incentive program account is automatically gets created by a web site for a user of a computer network, for example, the Internet, by using a unique client identifier placed by the web site on a computer of the user, without requesting any additional information from the user. In one embodiment, the web site automatically creates the incentive program account after the user accesses the web site for a certain number of times within a specified time period. Before creation of the account, the web site displays means to receive user approval to create the account. Approving the account indicates user binding to terms and conditions of the program and the account gets activated. After the creation of the account, visiting (browsing) behavior of the user is monitored and if the user performs an awardable activity, the user will be compensated, wherein the compensation is by means of adding value to the incentive program account in the form of bonus points. The user can redeem accumulated value for an award; however, the account is accessible by the user only if the web site receives the client identifier corresponding to the original client identifier that was used to create the account.

In another aspect of the invention, an incentive program provided to the users of a computer network allows users of the program to transfer earned values from one user account to other user's account to establish association of users belonging to a common group, for example, a family, a business and the like. The group benefits from quick redeem of awards by combining member bonus points; the web site benefits from forming anonymous group profile by using established association of users in conjunction with individual user profile from a cookie or similar database. The business entity may use this anonymous group profile for targeted marketing and to promote various products and services.

In one more aspect of present invention, a method of encouraging a user of a web site to anonymously identify with the web site using a single, consistent client identifier in following scenarios is provided: user accessing the web site from more than one computer and the user losing the original client identifier due to various reasons. According to this method, various means of recovering the original client identifier placed by the web site is provided. In one embodiment, the user associates the original client identifier with easily remembered answers to a set of questions. When accessing the web site from a different location, the user can reset with the web site to original client identifier by answering same set of questions. If answers match, the web site recovers the original client identifier and anonymously recognizes the user with the original client identifier. The user has choice of resetting the original client identifier temporarily during the visit or to permanently on the computer. If the user chooses later option, the web site creates or modifies a cookie file with the original client identifier. Since the client identifier is tied to an incentive program, users have more reason to do such recoveries.

In one more aspect of the present invention, a third party service provider maintains incentive programs on behalf of a plurality of web sites. A web site automatically sets up an incentive program account linked to a client identifier placed by the web site on a computer of the user, without requesting any additional information. Further the web site provides means to link the incentive program with the third party service provider. The web site needs to maintain only bare minimum data, while enjoying all the benefits, whereas the user can manage the account with the plurality of web sites from one central location. The web sites, further, benefit from quick establishment of the incentive program to users by leveraging the infrastructure of the third party service provider. Furthermore, this aspect of the invention introduces a new business model, which is the third party incentive program provider.

Still further objects and advantages will become apparent from a consideration of the ensuing detailed description and drawings.

### BRIEF DESCRIPTION OF THE DRAWINGS

The novel features of the invention are set out particularly in the appended claims, but the invention will be understood more fully and clearly from the following detailed description of preferred embodiments of the invention as set forth in the accompanying drawings, wherein, like reference numbers represent corresponding parts throughout, in which:

FIG.1 is a diagram that shows an exemplary computer network environment, in which the present invention may be practiced;

FIG. 2 is a block diagram illustrative of an exemplary system in which the present invention may be practiced;

FIG. 3 is a flow chart diagram illustrative of an incentive program account creation method tied to a user identifier placed by a web site on a computer of the user;

FIG. 4 is a block diagram that illustrates a web site creating an incentive program account for the user, without requesting any user related information and showing a screen asking for approval from the user to create such account;

FIG. 5 is a block diagram that illustrates an exemplary web page providing a hyperlink, indicative of establishment of the incentive program account with the web site;

FIG. 6 is a block diagram that illustrates an exemplary web page for managing the incentive program account;

FIG. 7 is a block diagram showing an exemplary web page for transferring points between accounts within a group, enabling the web site to identify anonymous group of users;

FIG. 8 is a flow chart diagram illustrative of a method of identifying anonymous group of users on a computer network in conjunction with an incentive program; and

FIG. 9 is a flow chart depicting a method of receiving a single, consistent anonymous user identifier from a user, regardless of accessing computer. This method also allows the user to recover lost original user identifier.

### DETAILED DESCRIPTION

In the following description, various methods of an incentive program that awards a user based on visiting (browsing) behavior of the user with a web site in conjunction to promote the usage of anonymously identifying the user and a group of the user with the web site is disclosed with various embodiments and examples.

The invention is described with respect to well-known wide area computer network, the Internet and the corresponding World Wide Web. Even though, the invention is described in terms of preferred embodiments and examples, these are for illustration and better understanding of the invention only and not to be construed as a limitation of the applicability and scope of protection of the present invention.

When this description refers to the term “web site”, it is implicit that there is an entity or entities behind such web site, which may benefit from the methods described herein. Moreover, the term “web site” implies a computer system that serves informational content over a network using the standard protocols of the World Wide Web. Typically a web site corresponds to a particular Internet domain name, such as “company1.com”, and includes the content associated with a particular organization. As used herein, the term is generally intended to encompass both (i) the hardware/software server components that serve the informational content over the network, and (ii) the “back end” hardware/software components, including any non-standard or specialized components, that interact with the server components to perform services for web site users, for example, web server, web application server, cookie database, associated web documents, any associated databases, etc. and not to be construed as a simple collection of web documents. Further, the web site may be hosted by another entity on behalf of the entity.

The term “Internet” used in this invention refers to a collection of interconnected (public and/or private) networks that are linked together by a set of standard protocols (such as TCP/IP and HTTP) to form a global, distributed network. While this term is intended to refer to what is now commonly known as the Internet, it is also intended to encompass variations that may be made in the future, including changes and additions to existing standard protocols. Similarly, the term “Intranet” refers to a private network of computer systems that are linked together by a set of standard protocols (such as TCP/IP and HTTP) to form a network accessible within a corporate or government entity.

This invention next describes current cookie process used by web sites for better understanding of the methods disclosed in later sections.

What are Cookies with Reference to the Internet?

Generally, cookie is a piece of text placed by a web site (web server) on a non-volatile memory of user's computer, for example, on a hard-disk of user's computer. Cookies allow a web site to store information on a user's computer and then later retrieve it. The pieces of information are stored as name-value pairs. For example, the web site might generate a unique user ID number for each visitor and store the ID number on each user's computer using a cookie file. In Microsoft windows operating system environment, these cookie files are typically located in c:\windows\cookies folder and there will be one file for each Web site that has placed a cookie file on the computer.

For example, if the user has visited company1.com, and the site has placed a cookie file on user's computer, the cookie file for company1.com may contain following information:
USERID xyz94859591D www.company1.com/

The vast majority of web sites store just one piece of information—a user identifier—on user's computer. However, a web site can write many name-value pairs within limited size of the cookie file. When the user types the uniform resource locator (hereinafter URL) of a web site into a web browser, the browser sends a request to the web site for the web page. For example, if user types www.company1.com, the browser will contact company1's web site and request its home page. When the browser does this, it will look on user's computer for a cookie file that company1 has set. If it finds a company1 cookie file, the browser sends all of the name-value pairs in the file to company1's server along with the URL. If it finds no cookie file, no cookie data will be sent. Company1's server (web site) receives the cookie data and request for a page. If name-value pairs are received, Company1's web site can use them; if no name-value pairs are received, Company1's web site knows that user have not visited the web site before. The web site creates a new user ID for the user in a cookie database of the web site and then sends corresponding name-value pairs to user's computer in the header for the web page it sends. The browser stores the name-value pairs on the hard-disk of user's computer, thus, creating a cookie file that may be used next time with the web site. Once a user ID is established, the web site literally can track all activities with the web site and store them in the cookie database, forming rich anonymous profile of the user.

Hardware Environment

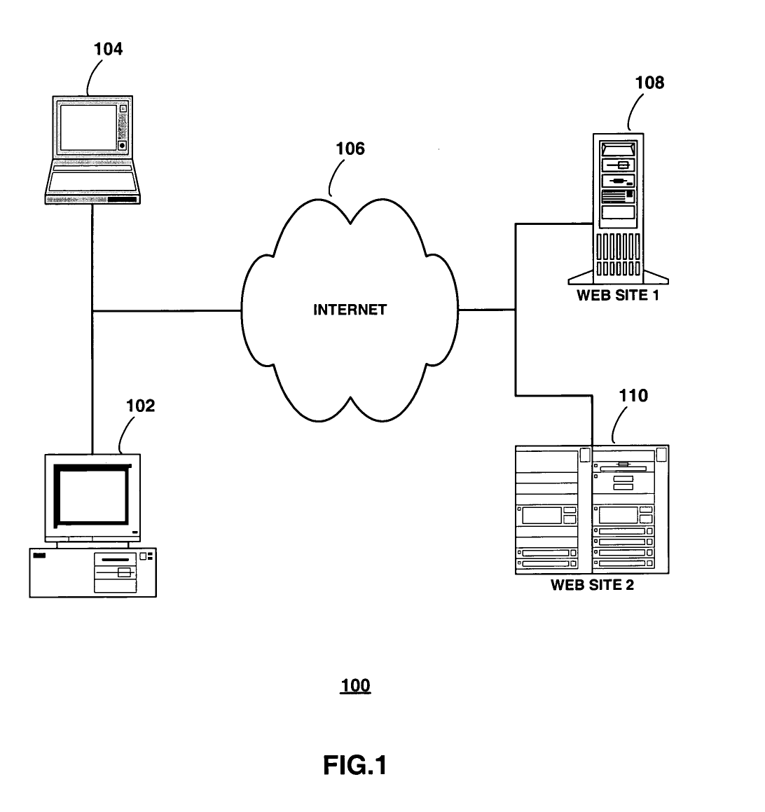

FIG. 1 depicts an exemplary computer network environment 100 where the present invention may be practiced. The network environment has a client computer 102, which is a desktop computer, another client computer 104, which is a laptop computer. Both of these computers can be linked to other computers via the Internet 106. Further, the environment 100 has server computers 108 and 110 representing a web site 1 and web site 2 respectively and is connected to the Internet 106. A user of the client computer 102 and 104 can access the web sites of server computers 108 and 110 by inputting appropriate URL into a web browser. The servers 108 and 110 run a software application program, commonly known as “Web server” to handle and manage user interaction with the web sites. By using the TCP/IP and HTTP standard protocols, the web browser can download web documents from the respective web site. It should be noted that same user might be accessing these web sites from different computers. For example, the user may use computer 102 to access these web sites from home and may use laptop computer 104 to access these web sites from office or during traveling. It should be also noted that the computer network environment 100 could be an intranet, instead of the Internet. Intranet is a computer network or collection of computer networks, wherein access to those sites are limited, for example, within a corporation or a government entity.

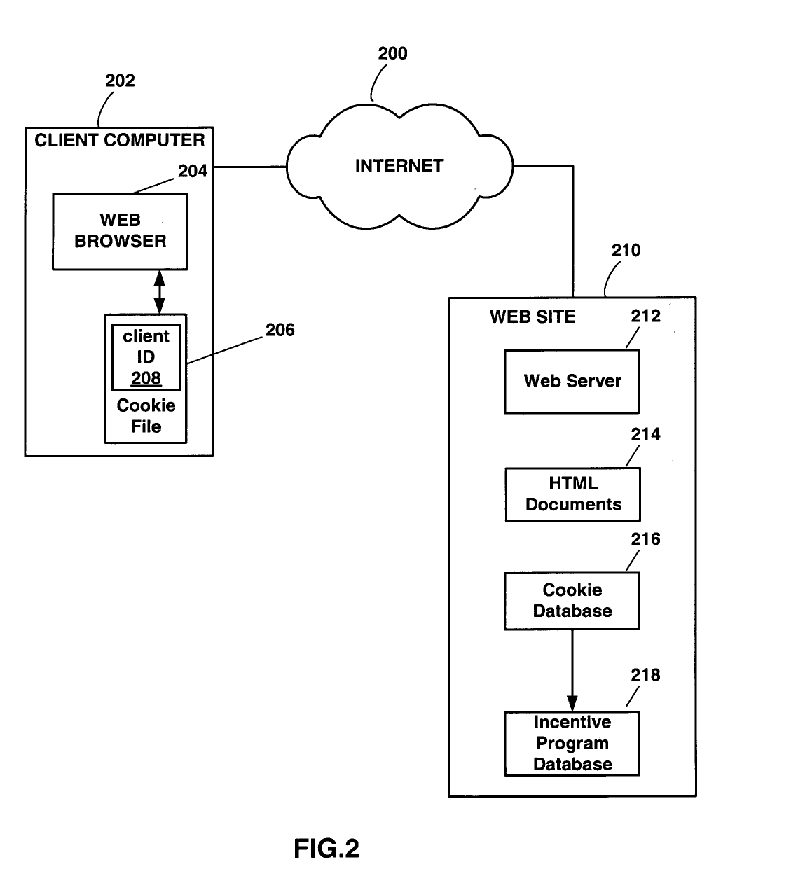

FIG. 2 shows one exemplary system in which the present invention may be practiced. A user of the Internet uses a client computer system 202 (user computer) connected to the Internet 200. The user accesses the web site 210 via the Internet, by typing the URL of the web site 210 in a web browser 204. During first visit, the web site 210 causes the web browser 204 to create a cookie file 206, with a unique user identifier or client identifier 208. During subsequent visits to the web site by the user, the browser 204 sends the unique user identifier 208 to the web site 210. The web site stores historical information, including activity history of the user with the web site in a cookie database 216. Over a certain period of time, after number of visits by the user, the cookie database 216 may contain rich profile of the user comprising the activities performed by the user with the web site 210. The web site comprises of web server 212 and HTML documents 214 comprising web pages of the web site 210. Incentive program database 218 comprises of the incentive program account information of the user and is linked to the cookie database 216 to leverage the information. The incentive program database is used to persist incentive program accounts of users and associated bonus points and other information pertaining to the incentive program. In many cases, this database may be an extension of the cookie database, for example, by adding few additional tables to an existing relational cookie database.

Incentive Program Account Creation Process.

In next sections, a method of establishing an incentive program account for a user by using a client identifier placed by the web site on a computer of a user, without requesting any user specific information is disclosed. The client identifier is used by the web site to anonymously identify the user. Unique feature of this account creation process is, it does not require user to provide any information related to the user and the account is created automatically without any direct involvement from the user, besides user approval to create the account. The user need not remember any login information to access the account, since the account is tied to the client identifier placed on the user's computer and automatic validation is done when the user logs into the web site using the computer on which the web site has placed the client identifier. In many cases the web site may use the client identifier itself as the account identifier. In other cases, the web site may link the account number to the client identifier such that the account number can be retrieved from the client identifier.

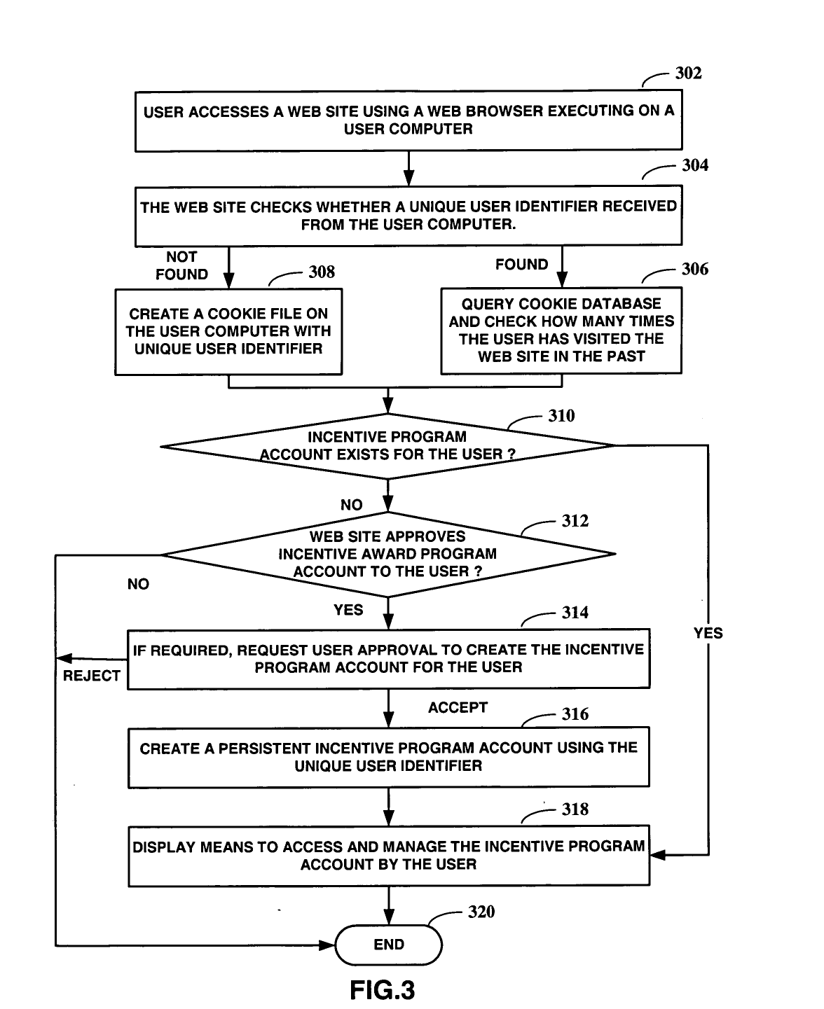

FIG. 3 depicts a flow chart of incentive program account creation method, in accordance with one embodiment of the present invention. This method is used by a web site to automatically setup an incentive program account for a user of the web site based on a client identifier (also referred in this disclosure as user identifier) placed by the web site, without requesting any additional information from the user. The method begins at step 302 with the user accessing the web site hosted on the Internet or on an Intranet, using a user computer or a computer connected to the Internet or to the Intranet.

Typically, if a cookie file or a similar file is present on the computer corresponding to the web site, the browser sends data found in the cookie file as name-value pairs to the web site. At step 304, the web site checks whether it received a unique user identifier (client identifier) from the user computer. If the unique user identifier is not found, process moves to step 308, where the web site creates unique user identifier and places it on a non-volatile memory of the user computer, by creating a cookie or similar file. During this step, the web site creates an entry in a cookie database also. In this illustration, if the unique user identifier is found, the process moves to step 306, wherein a query is made against a cookie or similar database to check how many times the user had visited the web site in the past. For example, some web sites may reserve the incentive program account to those users who have visited the web site, say, 5 times or more in last one year. Some web sites may provide this status to all visitors, who do not have such account already with the web site. In such scenarios the step 306 may be skipped.

At next step 310, the web site checks whether incentive program account already exist corresponding to the received user identifier. If the account does not exist, the process moves to next step 312. During this step, the web site may check whether the incentive program account can be granted to the user. This process is internal to each web site and may differ from one web site to other. In one scenario, the web site may not grant the account, if the user is relatively new to the web site; instead, the web site may display information regarding how to establish the account, for example a message “please visit our web site 4 more times within next 7 days and get automatically registered with our frequent visitor award program” may be displayed to the user along with the details of benefits offered in the program. In another scenario, a web site may grant the frequent visitor award account (incentive program account), for every visitor, even for a first time visitor. In such scenarios the step 312 may be skipped.

At next step 314, the web site provides an optional approval means to the user to receive the user input regarding the acceptance of the incentive program account. This step is optional, because technically, the incentive program account can be created without user approval, but for legal reasons, the web site may need to provide terms and conditions of the incentive program and creates the incentive program account, only if the user approves the creation by accepting to the terms and conditions. If the user rejects the account creation, process ends in step 320 without creating the account. If the user approves the creation of the account, process moves to step 316. In another scenario, this approval from the user may be received during activation of the account. The web site may create the account, but may not activate it till it receives the user approval.

At next step 316, the web site creates the incentive program account using the unique user identifier received from the user computer. It should be noted that in this method of present invention, the incentive program is created without directly requesting any user related information. In this context, the user related information implies to any user specific information, for example, name, address, email address, phone number, age, zip code and the like. This account is made persistent by saving in a database such that account can be accessed during subsequent visit and the user can accumulate bonus points against the account. The account number itself may be the user identifier value, or it may be a value derived from or linked to the user identifier value. In many cases the account number is the user identifier and the database may be a cookie database with some incentive program extensions.

After creating the incentive program account, or if the account already exists, the process moves to next step 318. At this step, the user is provided with indication of incentive program account by displaying an account accessing means. For example, a hyperlink in a web page will be displayed to the user and activating this hyperlink, brings up a screen to manage and view the incentive program account. The creation process ends at step 320.

It should be noted that entire process of creating the incentive program account is done without requesting any information from the user or without direct involvement of the user. The account is accessible only if the web site receives the client identifier linking the incentive program account. Moreover, if the user connects to the web site using the computer on which the web site has placed the client identifier, the user need not remember any username/password in order to access the incentive program account, because web site automatically receives the client identifier from the computer.

Once the incentive program account is established for the user, the web site can monitor the visiting (browsing) behavior of the user and if the user performs an awardable activity, a value will be added to the incentive program account. The awardable activity is, for example, but not limiting to, viewing an advertisement by clicking on the advertisement banner, participating in a survey, visiting a web site on a regular basis, visiting a web site during non-peak timings, downloading a software from website and the like. The value added to the account may be in the form of bonus points or may have a monetary nomination. After accumulating certain amount of value in the account, the user may redeem it for an award, for example, but not limiting to, a discount coupon, free subscription to a paid service with the web site for a certain period, chance to participate in a lottery, transfer to an airline frequent flyer program, transfer to a charity organization and the like.

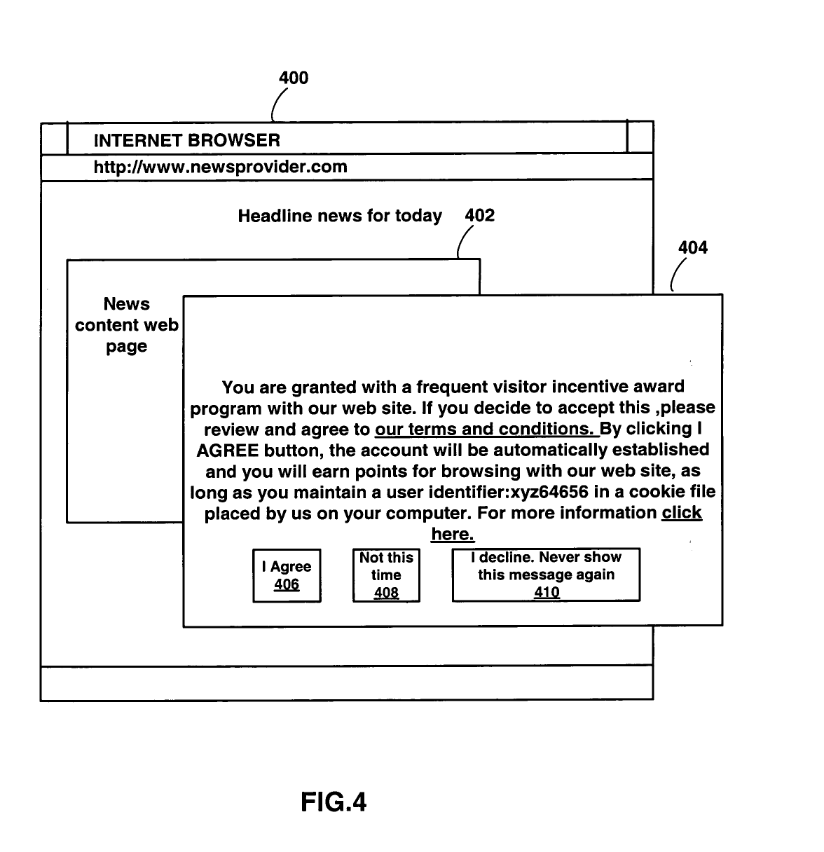

FIG. 4 depicts an exemplary approval means, corresponding to step 314 of FIG. 3. In this exemplary illustration, a user visits a news provider web site, newsprovider.com and downloads a web page into the web browser 400. The news section of the web page is shown by 402. The web site has placed a cookie file and anonymously identifies the user by a unique user identifier or client identifier “xyz64656”. Over the time, the web site has noticed that the user has been regularly visiting the web site and would like to maintain the relationship and like to encourage the user to browse more and decides to grant an incentive program account without requesting any information related to the user.

During browsing with the web site, the web site display a pop up screen 404 informing the user that it has granted the incentive program account and requests user approval to create the account. If the user decides to participate in the incentive program, only action the user has to do is to press the “I AGREE” button represented by 406. The user may request the web site to ask the same question again during subsequent browsing by selecting “Not this time” button 408. The user can decline and ask the web site to not to ask the same message again by clicking on button 410. If the user presses the button 408, the incentive program account is created without requesting any information related to the user. In following illustrations, the incentive program is also known by frequent visitor program.

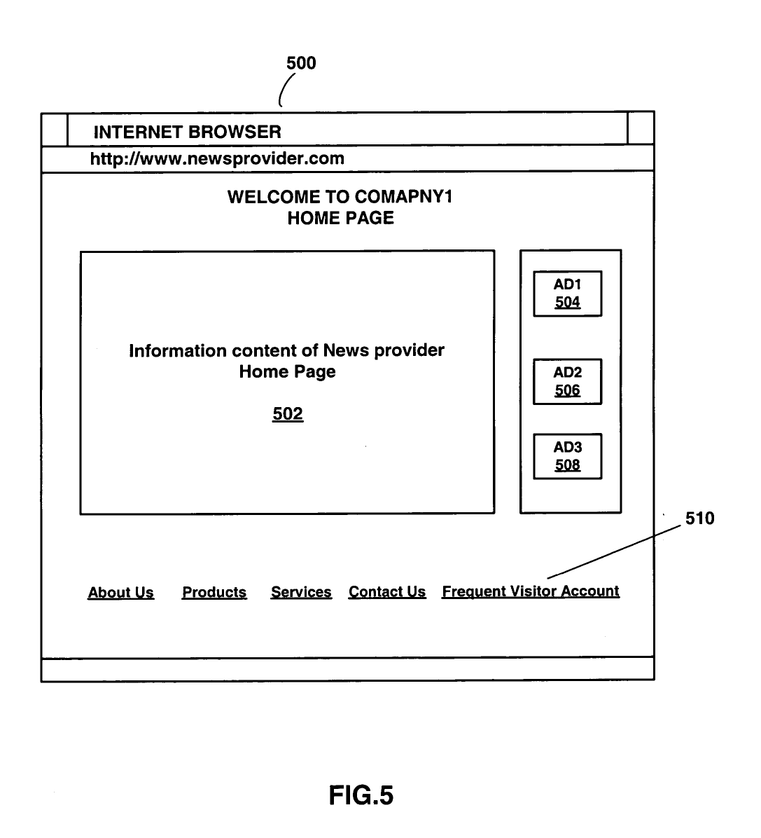

FIG. 5 illustrates an exemplary web page, if the user already has the incentive program account or has just approved the creation of the account with the web site. The user accesses the web site http://www.newsprovider.com using a web browser 500, wherein a web page consists of information section 502, advertisement icons 504, 506 and 508. The web site, using the method of the present invention, creates the incentive program account, which is represented by frequent visitor account and provides a hyperlink 510 (account accessing means) to access and manage the frequent visitor account.

The web site may monitor certain activities performed by the user with the web site. These activities may include, viewing advertisements, purchasing goods and services from the web site, participating in surveys, viewing positively priced information to the web site, such as product promotions, or in some cases, these activities may be general browsing done by the user, contributing to the profile created by the web site. If the activity is awardable, the web site may compensate the user, wherein the compensation comprises addition of values to the frequent visitor account. These values may be in form of bonus points, may have monetary nomination, or may be in any other awardable form.

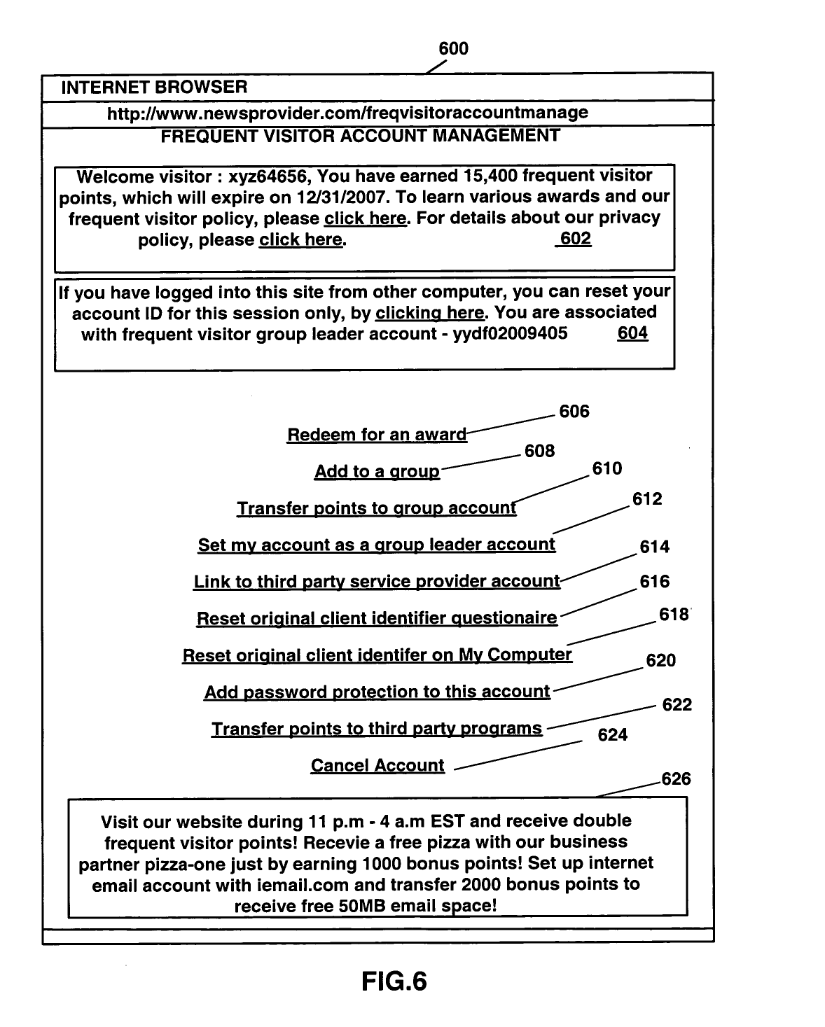

FIG. 6 illustrates an exemplary web page, the frequent visitor account management screen (incentive program account management screen) downloaded to the web browser 600, as a result of user clicking on the frequent visitor hyperlink 510 of FIG. 5. Frame 602 depicts textual information indicating the frequent visitor account number “xyz64656”, which is the unique user identifier placed by the web site on user's computer in a cookie file. Balance points available, expiry date, award details are also displayed and related detailed information may be available by clicking corresponding hyperlinks.

By clicking on redeem hyperlink 606, the user can redeem earned values in the frequent visitor account for various awards offered by the web site. The web site may offer the user some type of discount coupon in a store, an upgraded account status etc. For example, several free public web sites often have a fee-based membership, which provides additional services that are not available for free. The web site may provide such upgraded account status for free for certain amount of time as an award. In another example, the web site may allow the user to redeem certain points to participate in a lottery.

A hyperlink 614 or third party service provider linking means 614 allows the user to enter third party account information with a third party service provider. The third party service provider is an entity, which maintains incentive program account on behalf of at least one web site, but typically provides this service to a plurality of web sites. Using the services of third party service provider, the web site can quickly leverage existing infrastructure of the service provider and can easily provide such services to users with reduced time and cost. When using the services of third party service provider, the web site only stores linkage between the client identifier or incentive program account and information related to how to transfer earned values to the third party service provider account. The user can provide information related to third party service provider account by activating the third party service provider linking means. When the user performs an awardable activity with the web site, the information collected from third party service provider linking means is used to post earned value to third party service provider account.

Users can register with such third party service provider and may receive a third party service provider account. The users benefit from managing the incentive programs of a plurality of web sites from one centralized place. The web sites only post the value earned to the service provider and may not disclose the profile information of cookie database with the third party service provider. The user can connect to third party service provider web site and may get the account detail with each of the web site.

A password protection hyperlink 620 allows the user an added protection to the account by setting an optional password. A Cancel Account hyperlink 624 allows the user to cancel the frequent visitor account with the web site. Further, the web site can display advertisement like messages related to the frequent visitor award program in the frame 626. In one example, the web site declares double bonus points during non-peak timings to attract visitors. Other sections of FIG. 6 are described in detail in following sections.

The web site may allow the user to transfer earned values from the incentive program account to another third party incentive program. This third party incentive award program may be any kind of incentive program associated between a third party entity and the user. For example, the user may transfer earned bonus points in the incentive program account to an airline frequent flyer program using a means provided by the web site to transfer to the third party award program. Referring back to FIG. 6 now, the hyperlink 622 allows the user to transfer earned value to participating third party programs and represents an exemplary third party program transferring means. Activating this hyperlink may bring another screen with list of all participating third party award programs. The user may select one of them and transfer specified amount of points to other programs. It should be noted that third party program transferring means and third party service provider linking means are two separate topics of this detailed description section.

Anonymously Identifying Group of Individual Users.

In following sections, a method of identifying anonymous groups of users, for example, families, businesses etc, in conjunction with an incentive program provided to the users of a computer network is disclosed.

The method of anonymously identifying a group of individual users by a web site is associated with an incentive award program for an awardable activity performed with the web site. The incentive award program may be similar to the one, which is described in above sections or may be any incentive program provided on the computer network. This incentive program is provided to a plurality of users (visitors of the web site). A first user and at least one of a second user may be belonging to a common group, for example, a family, a business and the like. The web site provides transfer means to transfer earned values between incentive program accounts within the group. This provides an incentive to the group by quickly earning an award by combining values from individual accounts, whereas the web site identifies an association between users. When this association is used in conjunction with the individual user profile stored in a cookie or similar database, a rich anonymous group profile can be formed. The web site can use this profile for their benefit.

In one embodiment of this method, a first user registers his or her account as the group leader account with a web site and provides the account number to at least one of a second user, wherein the first user and the second user are belonging to a common group. The web site provides an association means to associate the second user with the first user. The second user, by using the association means, establishes a link to the group leader account by entering the group leader account number. If the second user decide to transfer some bonus points from a second user incentive program account to the first user incentive program account (the group leader account), the second user enters the value and activates the transfer using a group transfer means. This transfer causes the addition of specified value to the first user incentive program account.

Using the above embodiment, a business may provide a targeted advertisement to any member of the group. For example, a fast food restaurant may use this group profile to display a group discount coupon advertisement, preferably to the group leader. The advertisement for example, may display a message—“Buy 2 meals from us within next 2 days and get 3^{rd} one free”. Advertisements like this will have more impact with a family than with a single individual.

Referring back to FIG. 6, a group leader account hyperlink 612 allows one of a member of a group to register as the group leader account. This allows other members of the group to transfer their earned points to the frequent visitor account (incentive program account) of the group leader. This provides for quick redemption of awards by a group, or to get an award, which would have otherwise taken several points by a single member and longer time to accumulate those points. Other members of the group can associate with the group leader account by activating add to group means on a web page, which, in this exemplary illustration corresponds to add to a group hyperlink 608. Activating this hyperlink brings another screen, in which the group member can enter the frequent visitor account number of the group leader. This association will be stored in a persistent data store, for example, a database, and can be used in conjunction with the individual group member data stored in the cookie or similar database. Using this combination, the web site can form rich anonymous profile related to the group.

User can transfer earned value in the frequent visitor account to the group leader account by activating the transfer to group hyperlink 610. In the resulting screen, the user can specify how many points need to be transferred and clicking a group transferring means, causes the value to get transferred from the group member frequent visitor account to the group leader frequent visitor account. Association of the group member with the group leader may be displayed in a text block within frame 604. In another variation of this embodiment, the group leader account may need to accept the group member account. For example, the group member account tries to add to a group by activating the hyperlink 608 and by entering a group leader account number. This in turn will send a message to the group leader account with “yes” and “no” options. The group leader may approve this association by clicking “yes” option. This is referred in this invention as group approval means.

In another variation of this method, the group member may disclose the relationship with the group leader account only during transfer time. In this embodiment, the user need not pre-associate with any group leader account; instead, provides the group leader account number during transfer time.

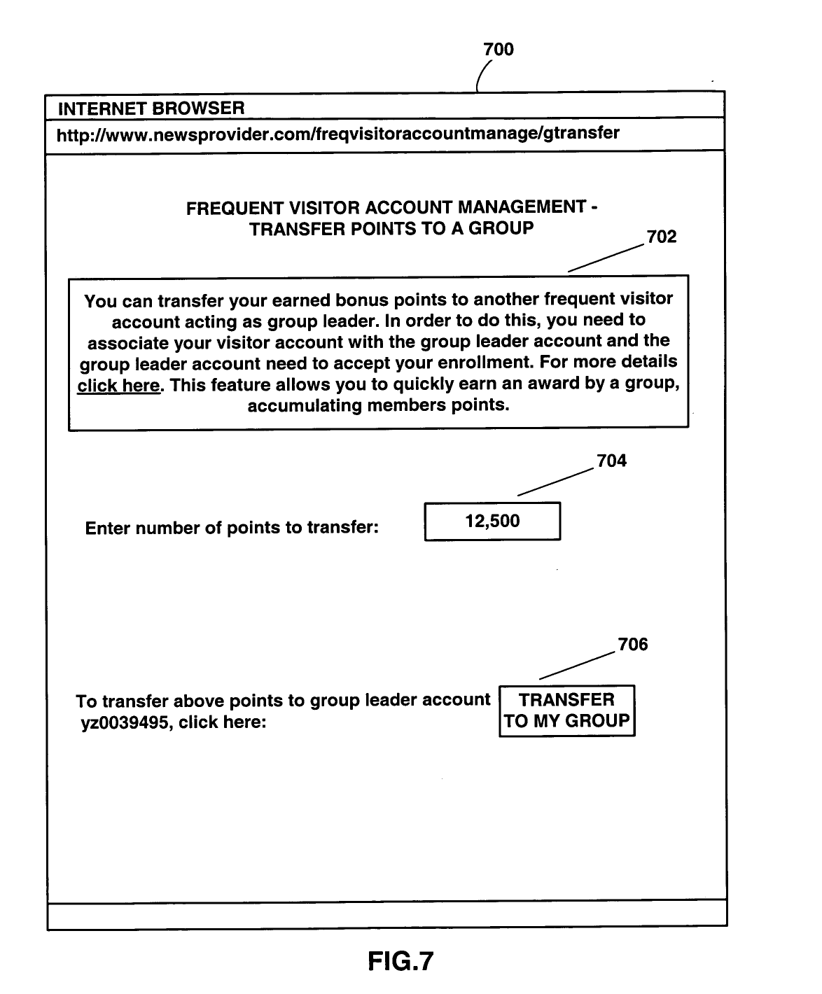

FIG. 7 depicts an exemplary screen that the web site brings up when the user activates the hyperlink 610 of FIG. 6. This exemplary screen is displayed within the web browser 700. Text frame 702 provides some useful information about this option. This web page further contains a data entry field 704 for specifying how many points need to be transferred to the group leader account and a group account transferring means 706. In this illustration, group account transferring means is a push button 706. If the value specified in the data entry field 704 is available in the frequent visitor account, corresponding value will be transferred to the group leader account.

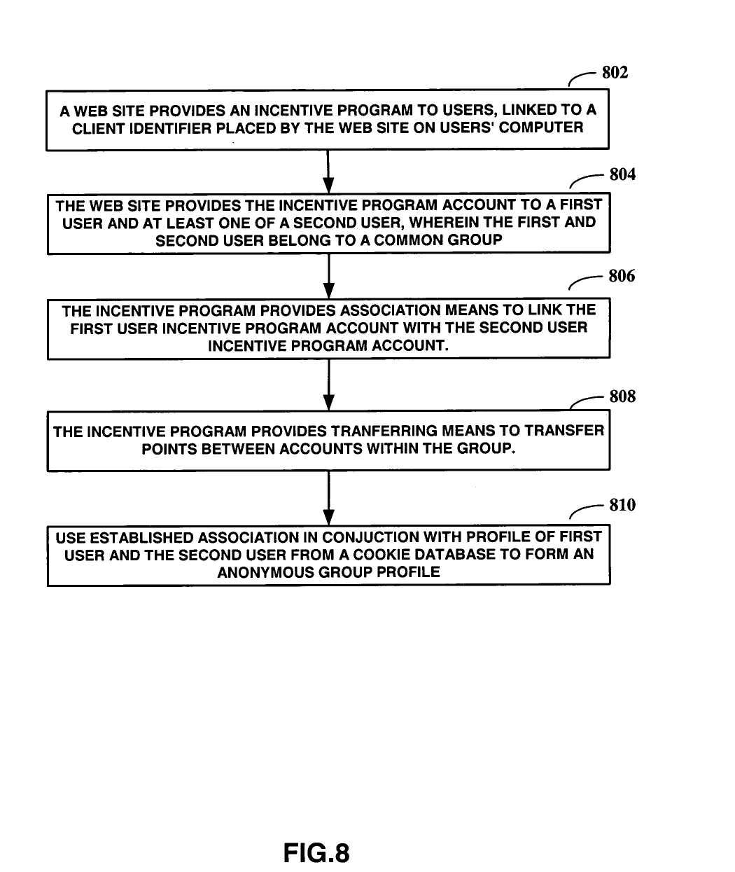

FIG. 8 depicts a flow diagram of the method of identifying group of anonymous users in conjunction with an incentive program. At step 802, the web site provides an incentive program tied to a client identifier placed by the web site on users' computer. This incentive program has a first user and one or more of a second user. The first user and the second user together belong to a common entity, for example, a family, a business etc. The web site provides the incentive program account for the first user and the second user as represented by step 804. At step 806, the incentive program provides an association means as described in earlier sections, using which, the first user and second user can establish the association. At step 808, the web site provides a transferring means to transfer earned values between accounts of the group as described in earlier sections. At step 810, the web site uses the established association between the first user and second user, in conjunction with a cookie or similar database having the individual profiles of first and second user to form an anonymous group profile.

It should be noted that the users belonging to a common group might be accessing a single, multi-user computer. For example, Microsoft Windows XP operating system allows multiple user access to a single computer with different login settings. With this setup, each user will have a different browser settings and their own set of cookie files, residing on the same computer.

Encouraging Users to Provide a Single Consistent Anonymous Identifier to the Web Site.

Another intention of this invention is to improve the quality of data collected in a cookie or similar database by the web site by providing a method to receive consistent anonymous user identifier from a user in conjunction with an incentive program.

The Internet user, typically can access the web site from multiple client computers (user computers), causing the web site to associate the same user with multiple different anonymous identifiers, further causing redundant and reduced quality of the data collected. Further, users can easily delete cookie files, causing loss of original user identifier placed by the web site. This is an even bigger loss for the web site, since all collected data in the cookie database will be useless, since the user is now recognized by a new anonymous identifier and the web site cannot associate the new identifier with the lost identifier. This can create several chunks of expired user identifiers in cookie database, which is really of no use to the web site.

As described in earlier sections, if the user loses the original client identifier corresponding to which the incentive program account was created, the user cannot access, earn or redeem bonus points against the account. In one way, this encourages the user to maintain and take care of their cookie or similar files. However, many times the user may be accessing the web site from a different computer. Moreover, the user may accidentally delete the cookie files, the hard disk of the computer may crash or the user may buy a new computer. In such scenarios, if the web site could provide means to recover and/or receive the original client identifier from the user, both the web site and the user will benefit.

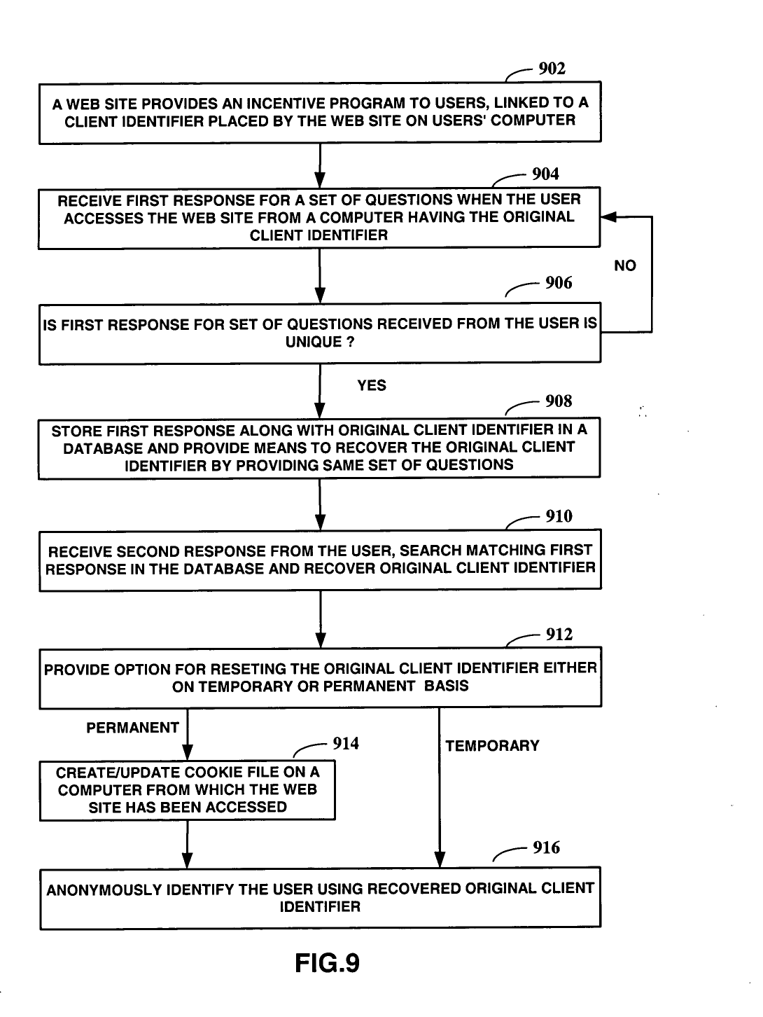

In one embodiment of this method of present invention, the web site provides an original client identifier recovery means, wherein the original client identifier is placed by the web site on a computer of a user in a cookie or a similar file and the original client identifier is lost on the part of the user. Referring now to FIG. 9, an illustration of method of providing means for original client identifier recovery in conjunction with an incentive program, at step 902, a web site provides an incentive program that is accessible only if the web site receives a client identifier linked with the incentive program account. At step 904, the web site provides means to receive response or first response from the user to a set of questions that the user can easily remember. This may be done by providing a web page with a set of questions, which the user may answer when the user accesses the web site from a computer that having the original client identifier.

At step 906, the web site checks whether it received a unique first response for the set of questions from the user. Response should be unique to avoid associating more than one client identifiers with identical response. If the response is not unique, the user is requested to provide different answers by going back to the step 906. If the response is unique, process of this method moves to next step 908. At step 908, the web site stores the first response along with the original client identifier and stores in a database and provides second means to recover the original client identifier to the user. This second means is a web page having same set of questions, wherein the web page gets displayed in response to the user clicking on a hyperlink, for example, “recover original client identifier”. The user is requested to answer same set of questions and at step 910, a second response from the user will be collected. If the web site finds a match between the second response and previously stored first response, the original client identifier associated with the response will be recovered.

At step 912, the user is provided with option of resetting the original client identifier on permanent or temporary basis. The user may opt for temporary basis, if the user is accessing the web site from a different computer. If the user selects this option, the recovered client identifier is used to anonymously identify the user for that session only. If the user has lost the client identifier from a computer that he or she uses regularly, the user may opt for permanent reset of the client identifier. At step 914, the web site creates the original client identifier on a computer that has been used to access the web site. This may be done by creating a new cookie file or by modifying existing cookie file on the computer. At step 916, the web site recognizes the user using the recovered original client identifier.

In another embodiment of this method, the web site provides means to directly input a different client identifier in a web page. For example, this may be done by displaying a data entry field for entering the different client identifier and receiving the different client identifier from the user. Intention of this embodiment is to encourage the user of the web site to maintain a single consistent client identifier for anonymously identifying with the web site on consistent basis when the user accessing the web site using a second computer, wherein the client identifier is placed by the web site on a first computer of the user.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A method for compensating a user of a computer network for performing an awardable activity with a web site connected to the computer network, wherein said compensation is by means of adding value to a persistent incentive program account and the incentive program account is linked to a client identifier placed by said web site on a computer of said user, the method comprising the steps of:
said user accessing said web site by connecting said computer to the computer network;
said web site checking whether it received said client identifier from said computer and if not received, creating said client identifier and placing it on said computer;
creating said incentive program account without requesting any user related information from said user;
associating said incentive program account with said client identifier, wherein subsequent access to said incentive program account is possible only if said web site receives said client identifier; and
detecting the awardable activity performed at said web site and compensating said user by adding value to said incentive program account.

2. The method of claim 1, wherein said creating incentive program account step further comprising of providing an approval means to said user and creating said incentive program account only after receiving approval from said user.

3. The method of claim 1, wherein said creating incentive program account step further comprising of providing an approval means to said user and activating said incentive program account only after receiving approval from said user.

4. The method of claim 1, wherein said client identifier is located within a cookie file placed by said web site on said computer.

5. The method of claim 1, further comprising the step of said user redeeming the accumulated value in said incentive program account for an award.

6. The method of claim 1 wherein said computer network is the Internet.

7. The method of claim 1, wherein said value is in the form of bonus points.

8. The method of claim 1, wherein said value having a monetary nomination.

9. The method of claim 1, wherein said establishing said incentive program account step further comprising the step of checking for eligibility of said user for granting the incentive program and requesting approval from said user only if said user is eligible.

10. The method of claim 9, wherein said checking for eligibility step comprising determining how many times said user had visited said web site and granting eligibility only if said user had visited more than the limit set by said web site.

11. The method of claim 1 further comprising the steps of:
providing association means to establish an association between said incentive program account and at least one of a second user incentive program account;
identifying a group using the established association; and
providing transfer means to transfer earned values between accounts within said group.

12. The method of claim 1 1, wherein the association of second user incentive program accounts with said incentive program account is used for anonymously identifying a group of related users, and associating independent data collected from the member of the group into a meaningful collection of data as applicable to the group.

13. The method of claim 12, wherein the collection of data corresponding to the group is used for targeted marketing to at least one member of said group.

14. The method of claim 11 further comprising the step of providing group approval means for approving the association by the users of said group.

15. The method of claim 1, wherein said awardable activity is viewing an advertisement hosted by said web site.

16. The method of claim 1, wherein said awardable activity is said user frequently visiting said web site on a regular basis.

17. The method of claim 1, wherein said awardable activity is said user participating in a survey.

18. The method of claim 1, wherein said web site providing third party program transferring means for transferring earned values in said incentive program account to a third party award program account.

19. The method of claim 1, wherein said web site providing third party service provider linking means for linking said incentive program account with a third party service provider account, wherein establishing the linking causes automatic transfer of earned values to said third party service provider account.

20. The method of claim 1 further comprising of providing a third party service provider maintaining the incentive program on behalf of at least one of said web site, wherein the third party service provider account of said user linking with at least one of said incentive program account, wherein performing an awardable activity with said web site causes addition of values to said third party service provider account.

21. A method of anonymously identifying a group of individual users, by a web site on a computer network, the method comprising:
providing an incentive program on the computer network to a first user and to at least one of a second user, wherein said incentive program for said first user is tied to a first user identifier placed by said web site on a computer of said first user and said incentive program for said second user is tied to a second user identifier placed by said web site on a computer of said second user;
providing association means to establish an association between the first user incentive program account and the second user incentive program account;
identifying the group using the established association; and
providing transfer means to transfer earned values between accounts within said group.

22. The method of claim 21 further comprising using a database having a profile of said first user and at least one of said second user in conjunction with identified association, to form a group profile.

23. The method of claim 21, wherein said providing association means step further comprising the steps of:
said first user registering said first user incentive program account as a group leader account; and
said second user associating said second user incentive program account with said group leader account.

24. The method of claim 21 further comprising the step of providing group approval means for approving the association by the users of said group.

25. The method of claim 21, wherein said group represents a family.

26. The method of claim 21, wherein said group represents a business.

27. The method of claim 21, wherein said computer of said first user and said computer of said second user is the same computer, wherein said first user and said second user represent different users having different login identifier on the same computer.

28. The method of claim 21, wherein said computer network is the Internet.

29. The method of claim 21, wherein said client identifier is located within a cookie file placed by said web site on said computer.

30. The method of claim 22, wherein said group profile is used for targeted marketing.

31. A method for receiving a consistent, anonymous user identifier by a web site connected to a computer network, from a user of the web site, regardless of accessing computer, using which the user accesses said web site, the method comprising:
said web site initially causing the creation of said anonymous user identifier on a first computer of said user;
providing an incentive program to said user, represented by a persistent incentive program account, wherein the account is linked to said anonymous user identifier and accessible by said user only if said web site receives said anonymous user identifier; and
providing means to anonymously identify with said web site using said anonymous user identifier from said accessing computer, wherein accessing computer initially identifies with said web site using a different user identifier.

32. The method of claim 31, wherein said means comprising:
providing at least one of a question to said user and receiving a first response from said user during said user anonymously identified with said web site using said anonymous user identifier and receiving a first response;
associating said first response with said anonymous user identifier and storing in a data store;
said user requesting recovery of said anonymous user identifier by selecting a recovery option and responding to said question again and said web site receiving a second response; and
said web site searching for matching first response using said second response, and if match is found, recovering said client identifier from said data store.

33. The method of claim 31, wherein said means further comprising the step of providing option for recovering said anonymous client identifier only for the session of the visit by said user with said web site, wherein activating the option causes said web site to anonymously recognize said user by said anonymous client identifier only for the session.

34. The method of claim 31, wherein said means further comprising the step of providing option for recovering said anonymous client identifier permanently on said accessing computer, wherein activating the option causes said web site to create said anonymous client identifier on said accessing computer.

35. The method of claim 31, wherein said means comprising the step of providing a data entry field to said user, wherein said user can enter said anonymous client identifier using the data entry field and providing said anonymous client identifier using the data entry field causes said web site to anonymously identify said user using said anonymous client identifier.

36. The method of claim 31, wherein said computer network is the Internet.
